(19) United States
(12) Patent Application Publication
(10) Pub. No.: US 2011/0258817 A1
(43) Pub. Date: Oct. 27, 2011

(54) METHOD AND APPARATUS FOR SECURING CARGO STRAPS

(76) Inventor: Chet Usher, Plum City, WI (US)

(21) Appl. No.: 13/086,005

(22) Filed: Apr. 13, 2011

Related U.S. Application Data
(60) Provisional application No. 61/326,771, filed on Apr. 22, 2010.

(51) Int. Cl. F16B 45/00; F16B 2/20; A44B 18/00

(52) U.S. Cl. 24/343; 24/369

(57) ABSTRACT

A method for securing a rolled cargo strap may include the steps of attaching a hook of a securing device to an attachment clip of the cargo strap. A strap of the securing device may be passed around a circumference of the rolled cargo strap so that the strap of the securing device is at least partially overlapped. A hook component may then be engaged with a loop component of hook and loop material attached to the strap of the securing device so that the strap of the securing device remains in an overlapped configuration.

### RELATED APPLICATIONS

This application claims the benefit of US Provisional Application No. 61326771 filed on Apr. 22, 2010

### BACKGROUND OF THE INVENTION

The present invention generally relates to a system for storing rolled cargo straps when the cargo straps are not in use.

Cargo straps may be employed when transporting objects in or on vehicles. Typically one end of a cargo strap may be attached to the vehicle, a free end may be passed over the cargo and the free end may be attached to the vehicle to secure the cargo to the vehicle. The vehicle may carry one or more of the cargo straps in a stored mode when there is no cargo on the vehicle. While the cargo straps are transported in a stored mode, they may be rolled into a compact shape.

As can be seen, there is a need to keep the cargo straps in the compact configuration while the vehicle may be traveling.

### SUMMARY OF THE INVENTION

In one aspect of the present invention, a device for holding a cargo strap in a rolled configuration may comprise: a hook; a strap engaged with the hook; a hook component of hook and loop material attached to a first side of the strap; and a loop component of the hook and loop material attached to a second side of the strap opposite the first side.

In another aspect of the present invention, a method for securing a rolled cargo strap may comprise the steps of: attaching a hook of a securing device to an attachment clip of the cargo strap; passing a strap of the securing device around a circumference of the rolled cargo strap so that the strap of the securing device is at least partially overlapped; engaging a hook component with a loop component of hook and loop material attached to the strap of the securing device so that the strap of the securing device remains in an overlapped configuration.

These and other features, aspects and advantages of the present invention will become better understood with reference to the following drawings, description and claims.

### BRIEF DESCRIPTION OF THE DRAWINGS

FIG. 1 is a first perspective view of a securing device in accordance with an embodiment of the invention;

FIG. 2 is a second perspective view of the securing device of FIG. 1 in accordance with an embodiment of the invention;

FIG. 3 is a perspective view of the invention the device of FIG. 1;

FIG. 4 is a side view of the device of FIG. 1;

FIG. 5 is a top view of a hook of the device of FIG. 1;

FIG. 6 is a perspective view of an alternate embodiment of a securing device;

FIG. 7 is a side view of an alternate embodiment of a hook of the device of FIG. 6;

FIG. 8 is a top view of the hook of FIG. 6;

FIG. 9 is a perspective view of a third embodiment of a securing device;

FIG. 10 is a side view of a hook of the device of FIG. 9; and

FIG. 11 is a top view of the hook of FIG. 9.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system for securing stored cargo straps in a rolled compact configuration on a moving vehicle.

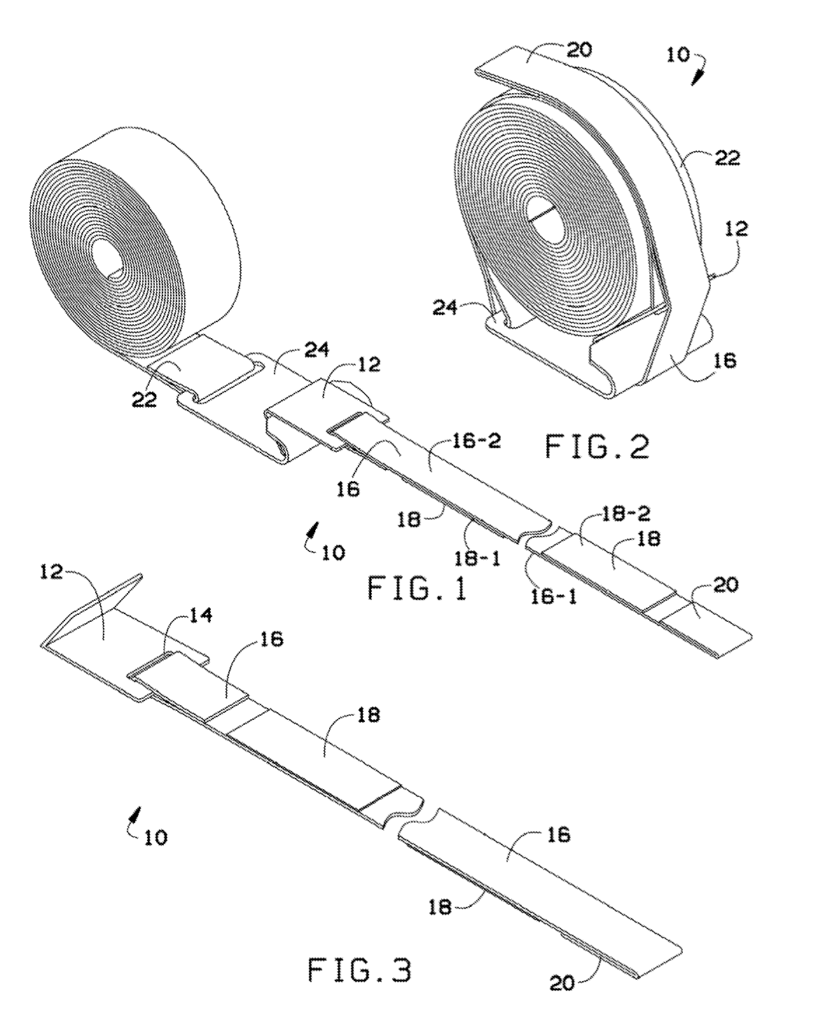

Referring now to FIG. 1, it may be seen that an exemplary embodiment of a cargo-strap securing device 10 may comprise a hook 12, a strap 16 and a pull tab 20. The hook 12 may be provided with a slot 14. Hook and loop material (e.g., Velcro®) 18 may be applied to the strap 16. The strap 16 may be constructed from nylon or polypropylene webbing and may be about one inch wide. The strap 16 may be engaged with the slot 14 with either a sewn loop or a heat sealed loop. A first component of the hook and loop material 18, for example a hook component 18-1, may be applied to a top side 16-1 of the strap 16. A second component of the hook and loop material 18, for example a loop component 18-2, may be applied to a bottom side 16-2 of the strap 16.

Referring now to FIG. 2, the device 10 may be seen in an operational mode. A cargo strap 22 may be rolled into a compact configuration. The hook 12 may be engaged with an attachment clip 24 of the cargo strap 22. The strap 16 may be passed around the rolled cargo strap 22 with the top side 16-1 facing outwardly and the bottom side 16-2 facing inwardly. The strap 16 may be passed over the attachment clip 24 and the overlapped onto itself so that the hook component 18-1 may be positioned to overlap the loop component 18-2. A user may tighten the device 10 by pulling on the pull tab 20. After the device 10 is tightened, the user may press on the strap 16 to engage the hook component 18-1 with the loop component 18-2 thereby locking the device 10 onto the rolled cargo strap 24 and securing the cargo strap 24.

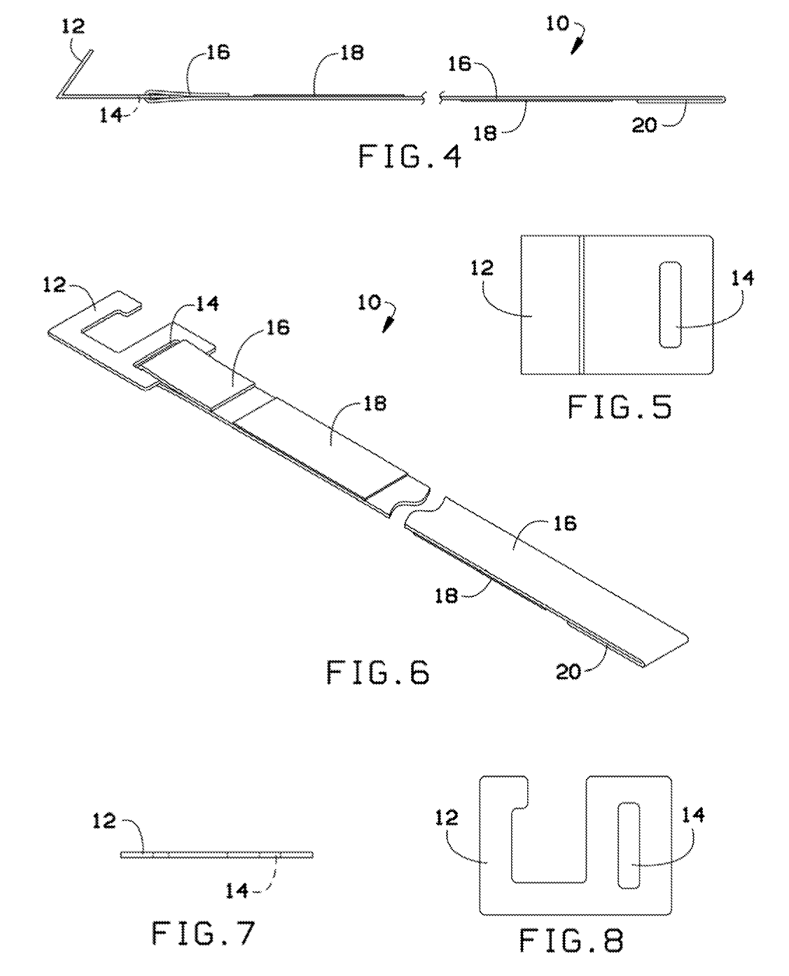

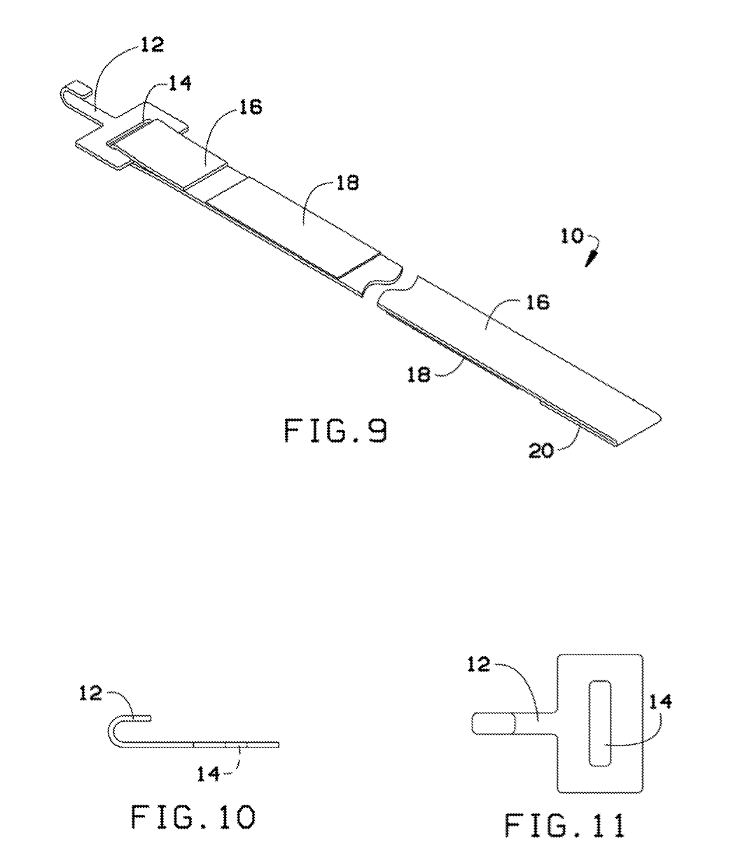

Referring now to FIGS. 3 through 11, it may be seen that the hooks may be constructed with various shapes in order to be properly engageable with various types of the attachment clip 24.

It may also be noted that the strap 16 may be made in various lengths to accommodate various roll sizes of the cargo straps 22. For any particular roll size, the hook component 18-1 and the loop component 18-2 may be displaced from one another along the strap 16 a distance that is appropriate to allow the hook and loop components to engage with one another when the device 10 surrounds the rolled cargo strap 22.

It should be understood, of course, that the foregoing relates to exemplary embodiments of the invention and that modifications may be made without departing from the spirit and scope of the invention as set forth in the following claims.

What is claimed is:

1. A device for holding a cargo strap in a rolled configuration comprising;
a hook
a strap engaged with the hook;
a hook component of hook and loop material attached to a first side of the strap; and
a loop component of the hook and loop material attached to a second side of the strap opposite the first side.

2. The device of claim 1 wherein the hook is configured to be engageable with an attachment clip of the cargo strap.

3. The device of claim 1 further comprising a pull tab formed at an end of the strap.

4. The device of claim 1 wherein at least a portion of the hook component and a portion of the loop component are displaced from one another on the strap a distance that exceeds a circumference of the rolled cargo strap.

5. The device of claim 1 wherein the hook comprises a slot and the strap is engaged with the slot.

6. A method for securing a rolled cargo strap comprising the steps of:
attaching a hook of a securing device to an attachment clip of the cargo strap;
passing a strap of the securing device around a circumference of the rolled cargo strap so that the strap of the securing device at least partially overlapped;
engaging a hook component with a loop component of hook and loop material attached to the strap of the securing device so that the strap of the securing device remains in an overlapped configuration.

7. The method of claim 6 wherein the step of passing the strap around the circumference comprises overlapping at least a portion of the hook component with at least a portion of the loop component.

8. The method of claim 6 wherein the step of passing the strap around the circumference comprises passing the strap of the securing device over the attachment clip of the cargo strap.

9. The method of claim 6 further comprising the step of pulling on a pull tab of the securing device to tighten the securing device on the rolled cargo strap.

10. The method of claim 9 wherein the step of engaging the hook component with the loop component is performed after the step of pulling on the pull tab to tighten the securing device.
